(19) United States
(12) Patent Application Publication
(10) Pub. No.: US 2006/0280982 A1
(43) Pub. Date: Dec. 14, 2006

(54) Membrane-electrode assembly for solid polymer electrolyte fuel cell

(75) Inventors: Nagayuki Kanaoka, Saitama (JP); Masaru Iguchi, Saitama (JP); Hiroshi Sohma, Saitama (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/429,228

(22) Filed: May 8, 2006

(30) Foreign Application Priority Data
Jun. 8, 2005 (JP) 2005-167745

(51) Int. Cl. H01M 8/10

(52) U.S. Cl. 429/33

(57) ABSTRACT

A membrane-electrode assembly for solid polymer electrolyte fuel cells is provided that exhibits higher proton conductivity and superior thermal resistance. A polyarylene having a sulfonic acid group and a nitrogen-containing heterocyclic aromatic compound are included in a solid polymer electrolyte membrane that constitutes the membrane-electrode assembly for solid polymer electrolyte fuel cells. Preferably, the polyarylene having sulfonic acid group contains a repeating unit expressed by the general formula (A) and a repeating unit expressed by the general formula (B) shown below.

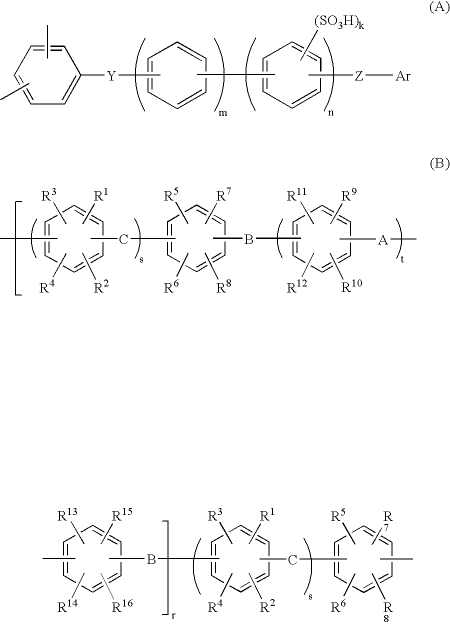

This application is based on and claims the benefit of priority from Japanese Patent Application No. 2005-167745, filed on 8 Jun. 2005, the content of which is incorporated herein by reference.

### BACKGROUND OF THE INVENTION

1. Field of the Invention

The present invention relates to membrane-electrode assemblies for solid polymer electrolyte fuel cells, which are equipped with solid polymer electrolyte membranes that exhibit improved thermal stability; thus, power generation durability may be enhanced in fuel cells operated at higher temperatures.

2. Related Art

Fuel cells generate electric power in a process in which hydrogen gas, produced from various hydrocarbon fuels such as natural gas and methane, and oxygen gas in air, are electrochemically reacted to generate electric power directly, and thus they have been attracting attention as non-polluting power generating systems that can directly convert chemical energy in fuels into electric energy with higher efficiency.

Assemblies of solid polymer electrolyte membranes and electrodes are typically employed in fuel cells, in which the assembly is typically constructed from a pair of catalyst-supporting electrode membranes of a fuel electrode and an air electrode as well as a proton-conductive electrolyte membrane (hereinafter sometimes referred to as a “solid polymer electrolyte membrane”) that is interposed between the electrode membranes. The hydrogen gas turns into hydrogen ions and electrons by the action of the catalyst on the fuel electrode, and then the hydrogen ions travel through the solid polymer electrolyte membrane to be converted into water by reaction with oxygen at the air electrode.

In recent years, fuel cells providing higher power generating performance have been desired. In order to enhance output of the power generation, the fuel cells should be operated at higher temperatures. Therefore, the assemblies of solid polymer electrolyte membranes and electrodes are desired to be able to operate under a broader range of conditions, in particular the membranes are desired to have higher proton conductivity at higher temperatures.

Polymers with a sulfonic acid group have been usually employed for the solid polymer electrolyte membranes so as to satisfy the demands. The applicant has also proposed certain polyarylenes having sulfonic acid group for providing solid polymer electrolyte membranes with higher proton conductivity (see Patent Documents 1 to 3).

Patent Document 1: Japanese Unexamined Patent Application Laid-Open No. 2004-345997

Patent Document 2: Japanese Unexamined Patent Application Laid-Open No. 2004-346163

Patent Document 3: Japanese Unexamined Patent Application Laid-Open No. 2004-346164

However, there are problems in the conventional solid polymer electrolyte membranes formed from polymers having sulfonic acid groups in that an elimination reaction is likely to occur reversibly on the sulfonic acid group and/or the cross-linking reaction may progress due to sulfonic acid at higher temperatures, which tend to decrease proton conductivity and/or embrittle the membranes, resulting possibly in decrease of power output of fuel cells and/or shutdown of power generation due to rupture of the membranes. In order to reduce the probability of these problems to be as low as possible, fuel cells are currently operated below a certain maximum temperature, which consequently results in a power generation output limit.

Accordingly, assemblies of solid polymer electrolyte membranes and electrodes have been desired to have a solid polymer electrolyte membrane that exhibits superior thermal resistance while maintaining the proton conductivity at the prior level.

### SUMMARY OF THE INVENTION

The present inventors have researched vigorously to solve the problems described above and have found that the problems may be solved by means of employing a solid polymer electrolyte membrane that contains a polyarylene having a sulfonic acid group and a nitrogen-containing heterocyclic aromatic compound, and thereby enhancing the high-temperature stability of the sulfonic acid group.

The membrane-electrode assemblies for solid polymer electrolyte fuel cells according to the present invention will be explained more specifically below.

According to a first aspect of the present invention, a membrane-electrode assembly for solid polymer electrolyte fuel cells includes: an anode electrode, a cathode electrode, and a solid polymer electrolyte membrane, the anode electrode and the cathode electrode disposed on opposite sides of the solid polymer electrolyte membrane, in which the solid polymer electrolyte membrane contains a polyarylene having a sulfonic acid group and a nitrogen-containing heterocyclic aromatic compound.

According to a second aspect of the present invention, in the membrane-electrode assembly for a solid polymer electrolyte fuel cells, the polyarylene having a sulfonic acid group contains a repeating unit expressed by the general formula (A) shown below and a repeating unit expressed by the general formula (B) shown below: 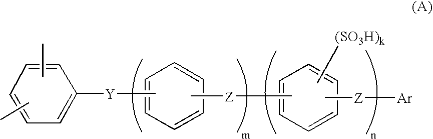
in the general formula (A), Y represents at least a structure selected from the group consisting of —CO—, —SO₂—, —SO—, —CONH—, —COO—, —(CF₂)₁— (1 is an integer of 1 to 10) and —C(CF₃)₂—; z represents a direct binding, or at least a structure selected from the group consisting of —(CH₂)₁— (l is an integer of 1 to 10), —C(CH₃)₂—, —O— and —S—; Ar represents an aromatic group having a substituent expressed by —SO₃H, —O(CH₂)ₚSO₃H or —O(CF₂)ₚSO₃H, in which p is an integer of 1 to 12, m is an integer of 0 to 10, n is an integer of 0 to 10, and k is an integer of 1 to 4; 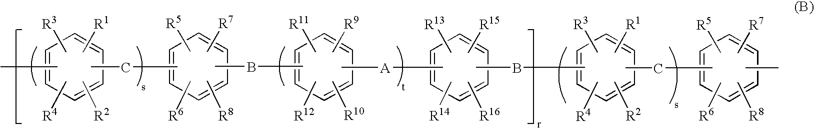
in the general formula (B), A and C represent independently a direct binding, or a structure selected from the group consisting of —CO—, SO₂—, —SO—, —CONH—, —COO—, —(CF₂)₁— (1 is an integer of 1 to 10), —C(CF₃)₂—, —(CH₂)₁— (1 is an integer of 1 to 10), —C(CR′₂)₂— (R′ is a hydrocarbon group or cyclic hydrocarbon group), —O— and —S—; B is independently an oxygen or sulfur atom; R¹ to R¹⁶, which may be identical or different from each other, represent at least an atom or a group selected from a hydrogen atom, fluorine atom, alkyl group, partly or fully halogenated alkyl group, allyl group, aryl group, nitro group and nitrile group; s and t are integers of 0 to 4; r is an integer of 0 or more than 1.

According to a third aspect of the present invention, in the membrane-electrode assembly for solid polymer electrolyte fuel cells, the nitrogen-containing heterocyclic aromatic compound is included in an amount of 0.01 to 20 mass parts based on 100 mass parts of the polyarylene.

According to a fourth aspect of the present invention, in the membrane-electrode assembly for solid polymer electrolyte fuel cells, the nitrogen-containing heterocyclic aromatic compound is at least one selected from the group consisting of pyrrole, thiazole, isothiazole, oxazole, isoxazole, pyridine, imidazole, pyrazole, 1,3,5-triazine, pyrimidine, pyridazine, pyrazine, indole, quinoline, isoquinoline, purine, benzimidazole, benzoxazole, benzthiazole, tetrazole, tetrazine, triazole, carbazole, acridine, quinoxaline, quinazoline, and derivatives thereof.

In accordance with the present invention, solid polymer electrolyte membranes may be provided, in which the sulfonic acid exhibits superior stability at higher temperatures without deteriorating inherent properties of polyarylenes by virtue of mixing polyarylenes essentially having excellent hot water resistance, higher concentrations of sulfonic acid and predominant proton conductivity and nitrogen-containing heterocyclic aromatic compounds. Accordingly, when the solid polymer electrolyte membranes are applied to membrane-electrode assemblies for solid polymer electrolyte fuel cells, electric power can be generated under a wide range of conditions of temperature and humidity, in particular at higher temperatures, and thus output of power generation can be raised significantly. Furthermore, the sulfonic acid group can attain superior stability even at higher temperatures; consequently, the fuel cells can display superior power generation stability for prolonged periods, generate higher outputs due to operation at higher temperatures and achieve remarkably long service life.

### DETAILED DESCRIPTION OF THE INVENTION

The best modes for carrying out the present invention will be explained in the following. That is, the membrane-electrode assemblies for solid polymer electrolyte fuel cells according to the present invention are electrode assemblies having a solid polymer electrolyte membrane that contains a polyarylene with a sulfonic acid group and a nitrogen-containing heterocyclic aromatic compound.

Sulfonated Polyarylene

Polyarylenes having sulfonic acid usable in the present invention will be first explained more specifically. The polyarylenes having sulfonic acid available in the present invention contain a repeating unit having a sulfonic acid group expressed by the general formula (A) (sulfonic acid unit) and a repeating unit having no sulfonic acid group expressed by the general formula (B) (hydrophobic unit), are a polymer expressed by the general formula (C).
Sulfonic Acid Unit

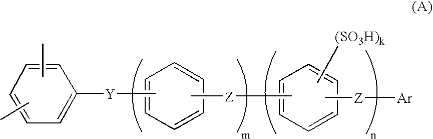

In the general formula (A), Y represents at least a structure selected from the group consisting of —CO—, —SO₂—, —SO—, —CONH—, —COO—, —(CF₂)₁— (1 is an integer of 1 to 10) and —C(CF₃)₂—. Among these, —CO— and —SO₂— are preferred.

Z represents a direct binding or at least a structure selected from the group consisting of —(CH₂)₁— (1 is an integer of 1 to 10), —C(CH₃)₂—, —O— and —S—. Among these, the direct binding and —O— are preferred.

Ar represents an aromatic group having a substituent expressed by —SO₃H, —O(CH₂)ₚSO₃H or —O(CF₂)ₚSO₃H (p is an integer of 1 to 12).

Specific examples of the aromatic groups include phenyl, naphthyl, anthryl, and phenanthryl groups. Among these groups, phenyl and naphthyl groups are preferred. The aromatic group should have at least a substituent expressed by —SO₃H, —O(CH₂)ₚSO₃H or —O(CF₂)ₚSO₃H (p is an integer of 1 to 12); preferably, the aromatic group has at least two substituents in the case in which the aromatic group is a naphthyl group.

The m is an integer of 0 to 10, preferably 0 to 2; n is an integer of 0 to 10, preferably 0 to 2; and k is an integer of 1 to 4.

The preferable combinations of integers m and n, structures of Y, Z, and Ar are as follows:

(i) m=0, n=0; Y is —CO—, Ar is a phenyl group with a substituent of —SO₃H

(ii) m=1, n=0; Y is —CO—, Z is —O—, and Ar is a phenyl group with a substituent of —SO₃H

(iii) m=1, n=1, k=1; Y is —CO—, Z is —O—, and Ar is a phenyl group with a substituent of —SO₃H

(iv) m=1, n=0; Y is —CO—, and Ar is a naphthyl group with two substituents of —SO₃H

(v) m=1, n=0; Y is —CO—, Z is —O—, and Ar is a phenyl group with a substituent of —O(CH₂)₄SO₃H
Hydrophobic Unit

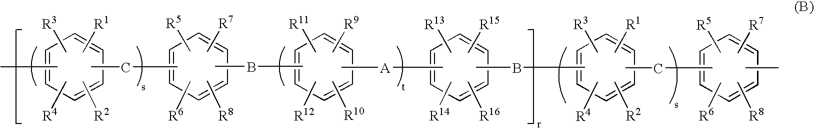

In the general formula (B), A and C represent independently of each other a direct binding, or at least a structure selected from the group consisting of —CO—, —SO₂—, —SO—, —CONH—, —COO—, —(CF₂)₁— (1 is an integer of 1 to 10), —C(CF₃)₂—, —(CH₂)₁— (l is an integer of 1 to 10), —C(CR′₂)₂— (R′ is a hydrocarbon group or cyclic hydrocarbon group), —O— and —S—. Specific examples, in which the structure is expressed by —C(CR′₂)₂— and R′ is a cyclic hydrocarbon group, include cyclohexylidene and fluorenylidene groups.

Among these, a direct binding, or —CO—, —SO₂—, —C(CF₃)₂—, —C(CR′₂)₂— (R′ is a hydrocarbon group or cyclic hydrocarbon group) and —O— are preferable. B represents independently an oxygen or sulfur atom.

R¹ to R¹⁶, which may be identical or different from each other, represent at least an atom or a group selected from a hydrogen atom, fluorine atom, alkyl group, partly or fully halogenated alkyl group, allyl group, aryl group, nitro group and nitrile group.

Examples of the alkyl groups include methyl, ethyl, propyl, butyl, amyl, hexyl, cyclohexyl and octyl groups. Examples of the halogenated alkyl groups include trifluoromethyl, pentafluoroethyl, perfluoropropyl, perfluorobutyl, perfluoropentyl and perfluorohexyl groups. Examples of the allyl groups include propenyl group; examples of the aryl groups include phenyl and pentafluorophenyl groups.

The s and t are integers of 0 to 4. The r is an integer of 0 or more than 1, and the upper limit is usually 100, and it is preferably 1 to 80.

Preferable combinations with respect to the values of s and t and structures of A, B, C and R¹ to R¹⁶ are as follows:

(i) s=1, t=1; A is —C(CF₃)₂— or —C(CR′₂)₂— (R′ is a hydrocarbon group or cyclic hydrocarbon group); B is oxygen atom; C is —CO— or —SO₂—; R¹ to R¹⁶ are hydrogen or fluorine atoms;

(ii) s=1, t=0; B is oxygen atom; C is —CO— or —SO₂—; R¹ to R¹⁶ are hydrogen or fluorine atoms;

(iii) s=0, t=1; A is —C(CF₃)₂— or —C(CR₁₂)₂— (R′ is a hydrocarbon group or cyclic hydrocarbon group); B is oxygen atom; R¹ to R¹⁶ are hydrogen atoms, fluorine atoms, or nitrile groups.

Polymer Structure

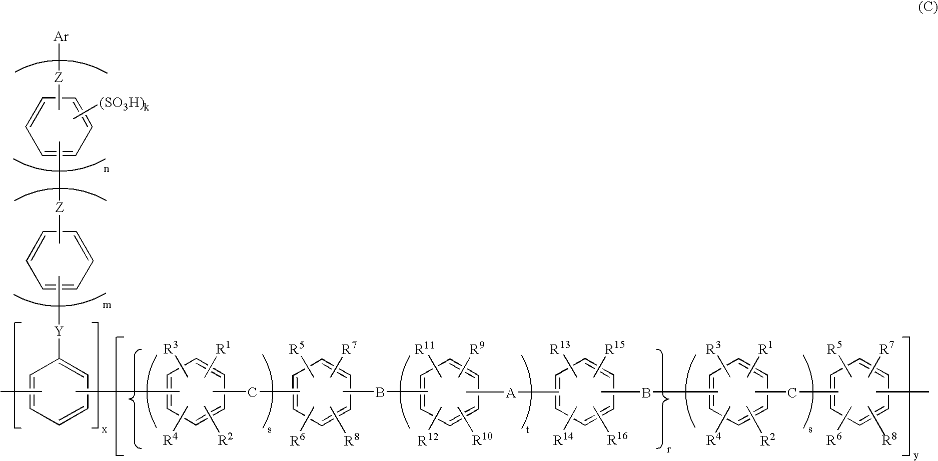

In the general formula (C), the meanings of A, B, C, Y, Z, Ar, k, m, n, r, s, t and R¹ to R¹⁶ are the same as those of A, B, C, Y, Z, Ar, k, m, n, r, s, t and R¹ to R¹⁶ in general formulas. (A) and (B). The x and y mean a mole ratio in which x+Y=100 mole %.

The polyarylenes having sulfonic acid usable in the present invention contain 0.5 to 100 mole %, preferably 10 to 99.999 mole % of the repeating unit expressed by the general formula (A), i.e., the x unit and 0 to 99.5 mole %, preferably 0.001 to 90 mole % of the repeating unit expressed by the general formula (B), i.e., the y unit.

Method of Producing Polymer

The polyarylenes having sulfonic acid may be produced, for example, by Method A, Method B, or Method C described below.

Method A:

A monomer, having a sulphonic ester group, capable of constituting the repeating unit expressed by the general formula (A), and a monomer or oligomer capable of constituting the repeating unit expressed by the general formula (B), are copolymerized in accordance with the method described in Japanese Unexamined Patent Application Laid-Open No. 2004-137444, for example, and thereby is prepared a polyarylene having a sulfonic ester group is, and then the sulfonic ester group is de-esterified to be converted into sulfonic acid group, and thereby a polyarylene having sulfonic acid group can be synthesized.

Method B:

A monomer, having a skeleton expressed by the general formula (A) and having neither sulfonic acid group nor sulfonic ester group, and a monomer or oligomer capable of forming the constitutional unit expressed by the general formula (B) are copolymerized in accordance with the method described in Japanese Unexamined Patent Application Laid-Open No. 2001-342241, for example, and then the resulting polymer is sulfonated by use of a sulfonating agent, and thereby a polyarylene having sulfonic acid group can be synthesized.

Method C:

In a case in which Ar is an aromatic group having a substituent expressed by —O(CH₂)ₚSO₃H or —O(CF₂)ₚSO₃H in the general formula (A), a precursor monomer capable of forming the constitutional unit expressed by the general formula (A) and a monomer or oligomer capable of forming the constitutional unit expressed by the general formula (B) are copolymerized in accordance with the method described in Japanese Unexamined Patent Application Laid-Open No. 2005-060625, for example, and then an alkylsulfonic acid or fluorinated alkylsulfonic acid is introduced to prepare a polyarylene.

Specific examples of monomers used in Method A, which are capable of forming the constitutional unit having the sulfonic ester group expressed by the general formula (A), include the sulfonic esters described in Japanese Unexamined Patent Application Laid-Open Nos. 2004-137444, 2004-345997 and 2004-346163.

Specific examples of monomers used in the Method B, which are capable of forming the constitutional unit expressed by the general formula (A), having neither sulfonic acid group nor sulfonic ester group, include the dihalogenated compounds described in Japanese Unexamined Patent Application Laid-Open Nos. 2001-342241 and 2002-293889.

Specific examples of precursor monomers used in the Method C, which are capable of forming the constitutional unit expressed by the general formula (A), include the dihalogenated compounds described in Japanese Unexamined Patent Application Laid-Open No. 2005-036125: specifically, 2,5-dichloro-4′-hydroxybenzophenone, 2,4-dichloro-4′-hydroxybenzophenone, 2,6-dichloro-4′-hydroxybenzophenone, 2,5-dichloro-2′,4′-dihydroxybenzophenone, and 2,4-dichloro-2′,4′-dihydroxybenzophenone. The compounds of which the hydroxyl group is protected by tetrahydropyranyl group or the like may also be used. The compounds of which the hydroxyl group is replaced by thiol group or of which the chlorine atom is replaced by bromine or iodine atom may also be used.

Specific examples of the monomer or oligomer, which are capable of forming the constitutional unit expressed by the general formula (B) usable in any methods in the case in which r=0, include 4,4′-dichlorobenzophenone, 4,4′-dichlorobenzanilide, 2,2-bis(4-chlorophenyl)difluoromethane, 2,2-bis(4-chlorophenyl)-1,1,1,3,3,3-hexafluoropropane, 4-chlorobenzoic acid-4-chlorophenylester, bis(4-chlorophenyl)sulfoxide, bis(4-chlorophenyl)sulfone, and 2,6-dichlorobenzonitrile. The compounds listed above, of which the chlorine atom is replaced by bromine or iodine atom, may be used.

In the case of r=1, the compounds described in Japanese Unexamined Patent Application Laid-Open No. 2003-113136 may be used for example.

In the case of r≧2, the compounds described in Japanese Unexamined Patent Application Laid-Open Nos. 2004-137444, 2004-244517 and 2004-346164 may be used for example.

In order to prepare the polyarylene having a sulfonic acid group, it is necessary that a monomer capable of forming the constitutional unit expressed by the general formula (A) and a monomer or oligomer capable of forming the constitutional unit expressed by the general formula (B) be copolymerized to prepare a precursor polyarylene. The copolymerization is achieved by use of a catalyst. The available catalysts contain a transition metal compound; the catalysts contain essentially (i) a transition metal salt and a ligand compound (hereinafter sometimes referred to as “ligand component”) or a transition metal complex with a coordinate ligand (including copper salt) and (ii) a reducing agent, and additionally an optional “salt” in order to increase the polymerization reaction rate.

The specific examples of the catalyst components, contents of respective components in use, solvents, concentration, temperature, period and the like in the reaction are illustrated, for example, in Japanese Unexamined Patent Application Laid-Open No. 2001-342241.

The polyarylenes having sulfonic acid group may be prepared by converting a polyarylene as its precursor into the corresponding polyarylene having sulfonic acid group. Such methods may be exemplified in the following three ways.

Method A:

The precursor polyarylene having sulfonic ester group is de-esterified in accordance with the method described in Japanese Unexamined Patent Application Laid-Open No. 2004-137444.

Method B:

The precursor polyarylene is sulfonated in accordance with the method described in Japanese Unexamined Patent Application Laid-Open No. 2001-342241.

Method C:

The precursor polyarylene is introduced with an alkyl sulfonic acid group in accordance with the method described in Japanese Unexamined Patent Application Laid-Open No. 2005-60625.

The ion-exchange capacity of the polyarylenes having sulfonic acid group expressed by general formula (C) is usually 0.3 to 5 meq/g, preferably 0.5 to 3 meq/g, more preferably 0.8 to 2.8 meq/g. The range of the ion-exchange capacity may lead to higher proton conductivity and superior water resistance. When the ion-exchange capacity is below the range, the power generating performance may be insufficient due to lower proton conductivity, and when the ion-exchange capacity is above the range, the water resistance may be remarkably degraded even though the proton conductivity is higher.

The ion-exchange capacity may be controlled, for example, by selecting the type, usage ratio and combination of the precursor monomer capable of constituting the repeating unit expressed by the general formula (A) and the monomer or oligomer capable of constituting the repeating unit expressed by the general formula (B).

The molecular weight of the resulting polyarylene having sulfonic acid group is 10,000 to 1,000,000, preferably 20,000 to 800,000 as the average molecular weight based on polystyrene standard by means of gel permeation chromatography (GPC).

Nitrogen-Containing Heterocyclic Aromatic Compound

The nitrogen-containing heterocyclic aromatic compounds usable in the present invention are an organic compound having a cyclic structure, that is, they are an aromatic compound having necessarily one or more nitrogen atom in addition to carbon atoms in the ring. There may exist other atoms such as sulfur, oxygen, phosphorous or arsenic atoms in the ring in addition to carbon and nitrogen atoms.

The nitrogen-containing heterocyclic aromatic compounds may be properly selected without particular limitations, and examples thereof include one or more compounds selected from the group consisting of pyrrole, thiazole, isothiazole, oxazole, isoxazole, pyridine, imidazole, pyrazole, 1,3,5-triazine, pyrimidine, pyridazine, pyrazine, indole, quinoline, isoquinoline, purine, benzimidazole, benzoxazole, benzthiazole, tetrazole, tetrazine, triazole, carbazole, acridine, quinoxaline, quinazoline and derivatives of these compounds. These compounds may be used alone or in combination. Composition for Forming Solid Polymer Electrolyte Membrane

By virtue of blending the nitrogen-containing heterocyclic aromatic compounds and the polymers having sulfonic acid group, there may be provided a highly thermally resistant membrane for solid polymer electrolyte fuel cells without diminishing proton conductivity. The nitrogen atom in the nitrogen-containing heterocyclic aromatic compounds is basic, and thus interacts ionically with the sulfonic acid group; consequently, the sulfonic acid group is stabilized and suppressed from detachment under higher temperatures. Furthermore, the cross-linking reaction due to the sulfonic acid group can be similarly suppressed between polymer molecules under higher temperatures. It is believed that the nitrogen-containing heterocyclic aromatic compounds have appropriate basic level to achieve these effects without deteriorating the proton conductivity.

The content of the nitrogen-containing heterocyclic aromatic compounds is 0.01 to 20 mass parts, preferably 0.5 to 10 mass parts based on 100 mass parts of sulfonated polyarylenes in the solid polymer electrolyte membranes of the inventive membrane-electrode assemblies for solid polymer electrolyte fuel cells. When the content of the nitrogen-containing heterocyclic aromatic compounds is less than 0.01 mass part, the effect of enhancing the thermal resistance may be insufficient, and when the content is more than 20 mass parts, the mechanical-thermal resistance of the membranes may be diminished due to plasticization and/or the proton conductivity may be decreased due to the lower level of sulfonic acid content in the solid polymer electrolyte membranes.

The mole ratio of the sulfonic acid group in the sulfonated polyarylenes and the nitrogen-containing heterocyclic aromatic compounds in the membrane-electrode assemblies for solid polymer electrolyte fuel cells of the invention is not specifically limited; usually the mole ratio of (sulfonic acid group)/(nitrogen-containing heterocyclic aromatic compound) is 0.005 to 2000, preferably 0.05 to 1000, more preferably 0.5 to 100. When the mole ratio of (sulfonic acid group)/(nitrogen-containing heterocyclic aromatic compound) is 2000 or more, the thermal stability of the sulfonic acid group is likely to be insufficient at the stage of power generation under higher temperatures; on the other hand, when the ratio is less than 0.005, the proton conductivity is likely to be insufficient since the concentration of the sulfonic acid group is remarkably low in the solid polymer electrolyte membranes even though the thermal stability of the sulfonic acid group may be enhanced.

The composition for forming solid polymer electrolyte membranes of membrane-electrode assemblies for solid polymer electrolyte fuel cells according to the invention contains sulfonated polyarylenes and nitrogen-containing heterocyclic aromatic compounds as described above. The contents or mole ratios are also described above. The sulfonated polyarylenes and nitrogen-containing heterocyclic aromatic compounds may be used after dissolving or dispersing into solvents described later as required; the amounts of the solvents will be described later. The composition may contain other components as required.

Membrane for Solid Polymer Electrolyte Fuel Cell

Solid polymer electrolyte membranes, used for the membrane-electrode assemblies for solid polymer electrolyte fuel cells of the invention, may be prepared by means of coating the composition for forming solid polymer electrolyte membranes on a surface of a substrate and drying it, as described in detail below.

Solid polymer electrolyte membranes may be produced by the following methods:

(i) dissolving a sulfonated polyarylene and a nitrogen-containing heterocyclic aromatic compound in a solvent in which both of the sulfonated polyarylene and the nitrogen-containing heterocyclic aromatic compound are soluble, the resulting solution is cast, followed by drying and removing the solvent to form a membrane;

(ii) a sulfonated polyarylene is formed into a membrane by a casting process, and then the resulting sulfonated polyarylene membrane is immersed into a solution of a nitrogen-containing heterocyclic aromatic compound, and thereby infiltrating the nitrogen-containing heterocyclic aromatic compound into the sulfonated polyarylene membrane;

(iii) a sulfonated polyarylene is formed into a membrane by a casting process, and then a nitrogen-containing heterocyclic aromatic compound is coated on the surface of the sulfonated polyarylene membrane by means of spray-coating a solution of a nitrogen-containing heterocyclic aromatic compound.

The method (i) may provide a feature that the membrane is produced with a substantially uniform composition. In the method (ii), the sulfonated polyarylene membrane should be insoluble in the solution of the nitrogen-containing heterocyclic aromatic compound. In the method (iii), the solvent of the nitrogen-containing heterocyclic aromatic compound is not restricted as the solvent in the method of (ii), since the nitrogen-containing heterocyclic aromatic compound is disposed only on or around the surface of the membrane.

The substrate used in the membrane-forming processes described above may be properly selected from those used in conventional solution-casting processes without particular limitations; for example, the substrate may be of plastics or metals, preferably the substrate is of thermoplastic resins such as polyethylene terephthalate (PET) films.

Specific examples of the solvents used in the membrane-forming processes include aprotic polar solvents such as N-methyl-2-pyrrolidone, N,N-dimethylformamide, gamma-butyrolactone, N,N-dimethylacetamide, dimethylsulfoxide, dimethylurea and dimethylimidazolizinone. Among these, N-methyl-2-pyrrolidone (hereinafter sometimes referred to as “NMP”) is preferred in particular from the viewpoint of solubility and solution viscosity. These aprotic polar solvents may be used alone or in combination.

The solvent may be a mixture of the aprotic polar solvent described above and an alcohol. Examples of the alcohol include methanol, ethanol, propyl alcohol, isopropyl alcohol, sec-butyl alcohol and tert-butyl alcohol. Among these, methanol is preferred since it can reduce the viscosity over a wider range of compositions. These alcohols may be used alone or in combination.

When the mixture of the aprotic polar solvent above and the alcohol is employed, the content of the aprotic polar solvent is 25 to 95 mass %, preferably 25 to 90 mass %, and the content of the alcohol is 5 to 75 mass %, preferably 10 to 75 mass %, with the proviso that the total is 100 mass %. The content of the alcohol within the range may provide a superior effect to decrease the solution viscosity.

In addition to the alcohols, inorganic acids such as sulfuric acid and phosphoric acid, organic acids such as carboxylic acids, or appropriate amount of water may be used together.

The concentration of the polymer in the solution for forming the membranes is typically 5 to 40 mass %, preferably 7 to 25 mass %. When the polymer concentration is less than 5 mass %, thicker membranes are hardly obtainable, and pinholes tend to form. On the other hand, when the polymer concentration is more than 40 mass %, the solution viscosity is too high to properly form the films, and also the surface smoothness may be deteriorated.

The solution viscosity is typically 2,000 to 100,000 mPa·s, and preferably 3,000 to 50,000 mPa·s. When the solution viscosity is less than 2,000 mPa·s, the retaining property of the solution is likely to be insufficient during the film-forming process, and thus the solution sometimes flows out of the substrate, and when the solution viscosity is more than 100,000 mPa·s, the viscosity is too high to extrude the solution from dies, and thus the films are difficult to produce by means of flowing processes.

The resulting non-dried films are immersed into water after the films are produced, and thereby the organic solvent in the non-dried film can be replaced with water, and the residual solvent can be reduced within the solid polymer electrolyte membranes. The non-dried films may be pre-dried before immersing them into water. The pre-drying is typically carried out in a condition of 50 to 150 degrees C. for 0.1 to 10 hours.

When the non-dried films (hereinafter including “films after pre-drying”) are immersed into water, the film pieces may be immersed into water in a batch process; alternatively, a continuous way may be carried out such that an intact laminate film formed on a substrate film (e.g. PET) or a membrane separated from a substrate is immersed into water and wound up successively. In the batch process, it is preferred that the non-dried films be fitted into frames and then immersed into water so as to prevent wrinkles on the surface of the films after the processing.

The amount of water used when immersing the non-dried films is 10 mass parts or more, preferably 30 mass parts or more, more preferably 50 mass parts or more, based on one mass part of the non-dried films. When the amount of water is within the range, the amount of solvent that remains within the resulting solid polymer electrolyte membranes may be reduced. Furthermore, the control of the concentration of organic solvents at or under a certain level, in a way that the water for immersion is exchanged or overflowed properly, for example, is effective to reduce the solvent that remains within the resulting solid polymer electrolyte membranes. Furthermore, the concentration of organic solvent in the water is effectively homogenized by means of stirring, for example, in order that the two-dimensional distribution of residual organic solvent may be reduced within the solid polymer electrolyte membranes.

The temperature of water, at which the non-dried films are immersed into water, is typically 5 to 80 degrees C., preferably 10 to 60 degrees C. from the viewpoint of replacing rate and easy handling. The higher the temperature, the higher the rate of replacing the organic solvent with water; however, the surface condition of the solid polymer electrolyte membranes may be deteriorated after drying since the amount of water absorbed into the films tends to increase with increasing temperature. The immersing period of films depends on the initial content of residual solvent, amount of water used, and processing temperature; the period is typically 10 minutes to 240 hours, preferably 30 minutes to 100 hours.

The non-dried films are immersed into water, and then the films are dried at 30 to 100 degrees C., preferably at 50 to 80 degrees C. for 10 to 180 minutes, preferably for 15 to 60 minutes, followed preferably by drying at 50 to 150 degrees C. under reduced pressure of 0.1 to 500 mm Hg for 0.5 to 24 hours, and thereby solid polymer electrolyte membranes may be obtained.

The content of the residual solvents within the solid polymer electrolyte membranes is typically reduced to no more than 5 mass %, preferably no more than 1 mass %.

The solid polymer electrolyte membranes produced by the method of the invention have typically a thickness of 10 to 100 μm, preferably 20 to 80 μm; the thickness may be controlled, for example, by adjusting the thickness of the substrate or frame.

Membrane-Electrode Assembly for Solid Polymer Electrolyte Fuel Cell

The membrane-electrode assemblies according to the present invention used for solid polymer electrolyte fuel cells may be obtained by means of providing an anode electrode layer and a cathode electrode layer on opposite sides of a solid polymer electrolyte membrane.

The catalysts on electrodes in the present invention are preferably a supported catalyst in which platinum or platinum alloy is supported on a porous carbon material. Carbon blacks or activated carbons may be used for the porous carbon material. Examples of the carbon blacks include channel blacks, furnace blacks, thermal blacks, and acetylene blacks; the activated carbons may be those produced through carbonizing and activating various carbon-containing materials.

Catalysts formed by supporting platinum or a platinum alloy on a carbon carrier may be used; platinum alloys may afford stability and activity to electrode catalysts. Preferably, platinum alloys are used which are formed from platinum and at least a metal selected from platinum group metals other than platinum (i.e., ruthenium, rhodium, palladium, osmium or iridium), or metals of other groups such as cobalt, iron, titanium, gold, silver, chrome, manganese, molybdenum, tungsten, aluminum, silicon, rhenium, zinc or tin; the platinum alloys may include an intermetallic compound which is formed of platinum and other metals alloyable with platinum.

Preferably, the supported content of platinum or platinum alloy (i.e. mass % of platinum or platinum alloy on the basis of the overall mass of catalyst) is 20 to 80 mass %, in particular 30 to 55 mass %, since the range may afford higher output power. When the supported content is less than 20 mass %, sufficient output power may not be attained, when over 80 mass %, the particles of platinum or platinum alloy may not be supported on the carrier of carbon material with sufficient dispersability.

The primary particle size of the platinum or platinum alloy is preferably 1 to 20 nm so as to obtain highly active gas-diffusion electrodes; in particular, the primary particle size is preferably 2 to 5 nm to ensure larger surface area of platinum or platinum alloy from the viewpoint of reaction activity.

The catalyst layers in the present invention include, in addition to the supported catalyst, an ion conductive polymer electrolyte or ion conductive binder that contains a sulfonic group. Usually, the supported catalysts are covered with the electrolyte, and thus a proton (H⁺) travels through the pathway of the connecting electrolyte.

Perfluorocarbon polymers exemplified by Nafion, Flemion and Aciplex are appropriately used for the ion conductive polymer electrolyte containing sulfonic acid group. Ion conductive polymer electrolytes based on the aromatic hydrocarbon compounds such as sulfonated polyarylenes described in this specification may be used in place of the perfluorocarbon polymers.

Preferably, the ion conductive binders are included in a mass ratio of 0.1 to 3.0, preferably 0.3 to 2.0 in particular based on the mass of the catalyst particles. When the ratio of the ion conductive binder is less than 0.1, protons may not be conducted into the electrolyte, and thus possibly resulting in insufficient power output; when the ratio is more than 3.0, the ion conductive binder may cover the catalyst particles completely, and thus gas cannot reach the platinum, resulting possibly in insufficient power output.

The method for forming the catalyst layer may be selected from conventional methods such that the supported catalyst and perfluorocarbon polymer having sulfonic acid group are dispersed into a medium to prepare a dispersion; optionally, a water repellent agent, pore-forming agent, thickener, diluent solvent and the like are added to the dispersion; then the dispersion is sprayed, coated or filtered on an ion-exchange membrane, gas-diffusion layer or flat plate. In the case in which the catalyst layer is not formed on the ion-exchange layer directly, the catalyst layer and the ion-exchange layer are preferably connected by means of a hot press or adhesion process, etc. (See Japanese Unexamined Patent Application Laid-Open No. 07-220741.)

The assemblies of solid polymer electrolyte membranes and electrodes according to the present invention may be formed solely of an anodic catalyst layer, a solid polymer electrolyte membrane, and a cathodic catalyst layer; more preferably, a gas diffusion layer formed of conductive porous material such as carbon paper and carbon cloth is disposed outside the catalyst layer along with the anode and cathode. The gas diffusion layer may act as an electric collector, and therefore, the combination of the gas diffusion layer and the catalyst layer is referred to as an “electrode” in this specification when the gas diffusion layer is provided.

The method for producing the assemblies of solid polymer electrolyte membranes and electrodes may be selected from various methods, for example, a catalyst layer is formed directly on an ion-exchange membrane and is sandwiched with a gas diffusion layer as required; a catalyst layer is formed on a substrate for a gas diffusion layer such as carbon paper, and then the catalyst layer is connected with an ion-exchange membrane; a catalyst layer is formed on a flat plate, the catalyst layer is transferred onto an ion-exchange membrane, and then the flat plate is peeled away, and sandwiched with a gas diffusion layer as required.

In the solid polymer electrolyte fuel cells equipped with the assemblies of solid polymer electrolyte membranes and electrodes according to the present invention, oxygen-containing gas is supplied to the cathode and hydrogen-containing gas is supplied to the anode. Specifically, separators having channels for gas passage are disposed outside both electrodes, gas is flowed into the passage, and thereby the gas for fuel is supplied to the assembly of solid polymer electrolyte membrane and electrode. As described above, the assemblies of solid polymer electrolyte membrane and electrode according to the present invention may yield highly effective power generation under lower humidity conditions in particular.

### EXAMPLES

The present invention will be explained more specifically with reference to examples, which are not intended to limit the scope of the present invention.

In the examples described below, determinations of sulfonic acid equivalent and molecular weight, preparation of solid polymer electrolyte membranes, production of assemblies of solid polymer electrolyte membranes and electrodes were carried out as follows.

Sulfonic Acid Equivalent

The resulting sulfonated polymers having sulfonic acid group were washed with deionized water until the washed water became neutral so as to sufficiently remove free residual acid, and then were dried. The polymers were then weighed in a predetermined amount and dissolved in a mixture of solvents of tetrahydro furan (THF)/water; then the solutions were titrated with a NaOH standard solution using phenolphthalein as an indicator and the sulfonic acid equivalent was determined from the neutralization point.

Determination of Molecular Weight

Weight average molecular weight of polyarylenes with no sulfonic acid group was determined as the molecular weight based on a polystyrene standard by means of gel permeation chromatography (GPC) using tetrahydrofuran (THF) for the solvent.

Molecular weight of polyarylenes having sulfonic acid group or molecular weight of polyarylenes having sulfonic acid group after the evaluation of thermal resistance was determined as the molecular weight based on a polystyrene standard by means of GPC using a mixture of solvents containing 7.83 g of lithium bromide, 3.3 ml of phosphoric acid and 2 L of N-methyl-2-pyrrolidone (NMP) as an eluting solvent.

Preparation of Solid Polymer Electrolyte Membrane

By a casting process, cast membranes were prepared from 15 mass % solution of the resulting sulfonated polyarylenes, in which the solvent was a mixture of methanol in the capacity ratio 50/50 of methanol/NMP. The cast membranes were immersed overnight in a large amount of disuntiled water, the residual NMP in the membranes was removed by action of dilution, and then the membranes were dried to obtain the desired membranes 40 μm thick.

When solid polymer electrolyte membranes were prepared from nitrogen-containing heterocyclic aromatic compounds and sulfonated polyarylenes as described in the Examples, varnishes were prepared by dissolving a predetermined amount of the nitrogen-containing heterocyclic aromatic compounds and the resulting sulfonated polyarylenes into 50/50 capacity ratio of methanol/NMP so as to correspond to 15 mass % solute. In the way as described above, the varnishes were formed into cast membranes, from which the residual NMP in membranes was removed by means of immersing in a large amount of distilled water, and thereby to obtain the desired membranes which were 40 μm thick.

Preparation of Assembly of Solid Polymer Electrolyte Membrane and Electrode

i) Catalyst Paste

Platinum particles were supported in a carbon black (furnace black) having an average particle size of 50 nm in a mass ratio 1:1 of carbon black:platinum to thereby prepare catalyst particles. The catalyst particles were then dispersed uniformly into a solution of perfluoroalkylene sulfonic acid polymer compound (Nafion (product name), by DuPont) as an ion conductive binder in a weight ratio 8:5 of ion conductive binder:catalyst particles thereby, preparing a catalyst paste.

ii) Gas Diffusion Layer

The carbon black and polytetrafluoroethylene (PTFE) particles were mixed in a mass ratio 4:6 of carbon black:PTFE particles, the resulting mixture was dispersed uniformly into ethylene glycol to prepare a slurry, and then the slurry was coated and dried on one side of a carbon paper to form an underlying layer; consequently, two gas diffusion layers were prepared, which were formed of the underlying layer and the carbon paper.

iii) Preparation of Electrode-Coating Membrane (CCM)

To both sides of the solid polymer electrolyte membranes, prepared in this Examples, the catalyst paste described above was coated by use of a bar coater in an amount that the platinum content was 0.5 mg/cm², and dried to prepare an electrode-coating membrane (CCM). In the drying step, a first drying at 100 degrees C. for 15 minutes was followed by a secondary drying at 140 degrees C. for 10 minutes.

iv) Preparation of Assembly of Solid Polymer Electrolyte Membrane and Electrode

Assemblies of membranes and electrodes were prepared in such a way that the CCM was gripped at the side of the underlying layer of the gas diffusion layer, and then was subjected to hot-pressing. In the hot-pressing step, a first hot-pressing at 80 degrees C. and 5 MPa for 2 minutes was followed by a second hot-pressing at 160 degrees C. and 4 MPa for 1 minute.

In addition, solid polymer electrolyte fuel cells may be constructed from the membrane-electrode assemblies according to the present invention in such a way that a separator, being also usable as a gas passage, is laminated on the gas diffusion layer.

### SYNTHESIS EXAMPLES AND EXAMPLES

### Synthesis Example 1

Into a three-necked flask, equipped with a cooling pipe and a three-way stopcock were weighed 185.3 g (540 mmol) of 2,5-dichloro-4′-phenoxybenzophenone, 15.1 g (60 mmol) of 4,4′-dichlorobenzophenone, 11.7 g (78 mmol) of sodium iodide, 11.8 g (18 mmol) of bis(triphenylphosphine)nickeldichloride, 63.0 g (240 mmol) of triphenylphosphine and 94.1 g (1.44 mol) of zinc, the flask was dipped into an oil bath at 70 degrees C. and purged with nitrogen gas, and then 1000 ml of N-methyl-2-pyrrolidone was added under a nitrogen atmosphere and the reaction was initiated.

After being allowed to react for 20 hours, the reaction mixture was diluted with 500 ml of N-methyl-2-pyrrolidone, the polymerization reaction liquid was poured into a solution of 1/10 of HCl/methanol to thereby make the polymer precipitate, the precipitation was washed, filtered and vacuum-dried, resulting in a white powder. The yield was 153 g. The weight average molecular weight was 159,000. The polymer of 150 g was sulfonated by so that 1500 ml of concentrated sulfuric acid was added to the polymer and stirred at ambient temperature for 24 hours. Following the reaction period, the reaction mixture was poured into a large amount of deionized water, and thereby sulfonated polymer was precipitated. The polymer was washed with deionized water until the washed water had a pH of 7, and then the polymer was filtered, recovered, and vacuum-dried at 90 degrees C. The yield of the sulfonated polymer was 179 g. The polymer had an ion-exchange capacity of 2.3 meq/g and a weight average molecular weight of 183,000.

The resulting polymer was expressed to be expressed by the general formula (A) below; such a polymer having sulfonic acid group is denoted as “Polymer A”.

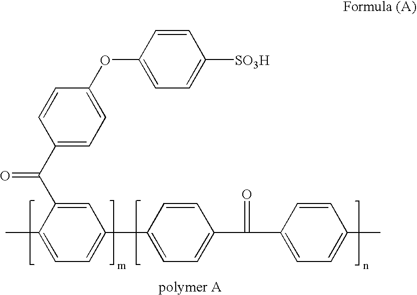

### Synthesis Example 2

(i) Synthesis of Hydrophobic Unit B

Into a 1 L three-necked flask equipped with a stirrer, a thermometer, a Dean-Stark apparatus, a nitrogen inlet, and a cooling pipe were weighed 29.8 g (104 mmol) of 4,4′-dichlorodiphenylsulfone,

37.4 g (111 mmol) of 2,2-bis(4-hyroxyphenyl)-1,1,1,3,3,3-hexafluoropropane and 20.0 g (145 mmol) of potassium carbonate. After purging with nitrogen gas, 168 ml of sulfolane and 84 ml of toluene were added and stirred, and then the reaction liquid was heated to 150 degrees C. and refluxed by use of an oil bath. Water generated through the reaction was trapped in the Dean-Stark apparatus. When water generation fell to nearly zero after three hours, toluene was removed from the Dean-Stark apparatus. The temperature of the reaction mixture was gradually raised to 200 degrees C., stirring was continued for 5 hours, and then 7.5 g (30 mmol) of 4,4′-dichlorodiphenylsulfone was added, and this was allowed to further react for 8 hours.

The reaction liquid was allowed to cool and then diluted by adding 100 ml of toluene. Inorganic salts which were insoluble in the reaction liquid were filtered, and then the filtrate was poured into 2 L of methanol to cause precipitation. The precipitated product was filtered, dried, and then dissolved into 250 ml of tetrahydrofuran, and then the solution was poured into 2 L of methanol to cause re-precipitation. The precipitated white powder was filtered and dried, and thereby 56 g of hydrophobic unit B expressed by formula (B-1) was obtained, of which the number average molecular weight (Mn) was 10,500 measured by GPC. 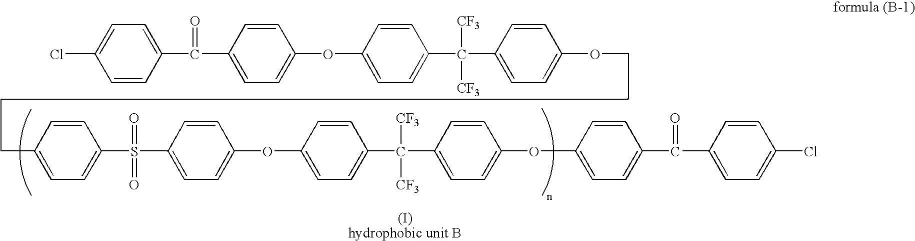
(ii) Synthesis of Sulfonated Polyarylene B

Into a 1 L three-necked flask, equipped with a stirrer, a thermometer, and a nitrogen inlet, were weighed 141.5 g (337 mmol) of 3-(2,5-dichlorobenzoyl)benzenesulfonic acid neopentyl, 48.5 g (4.6 mmol) of the hydrophobic unit B obtained in (i) described above, 6.71 g (10.3 mmol) of bis(triphenylphosphine)nickeldichloride, 1.54 g (10.3 mmol) of sodium iodide, 35.9 g (137 mmol) of triphenylphosphine and 53.7 g (821 mmol) of zinc, and then purging with dry nitrogen gas. To the mixture, 430 mL of N,N-dimethylacetamide (DMAc) was added, the reaction mixture was maintained at 80 degrees C. and was stirred successively for 3 hours, and then the reaction mixture was diluted with 730 mL of DMAc, and insoluble matter was filtered out.

The resulting solution was poured into a 2 L three-necked flask, equipped with a stirrer, a thermometer, and a nitrogen inlet, and then the content was stirred while heating at 115 degrees C. and 44 g (506 mmol) of lithium bromide was added. After stirring for 7 hours, the reaction mixture was poured into 5 L of acetone to thereby precipitate the product. The resulting product was rinsed with 1N HCl and deionized water in order, and then dried to obtain the intended sulfonated polymer of 124 g. The weight average molecular weight of the resulting polymer was 170,000.

The resulting polymer was considered to be the sulfonated polymer (Polymer B) expressed by the formula (B-2) below. The ion-exchange capacity of the polymer was 2.3 meq/g.

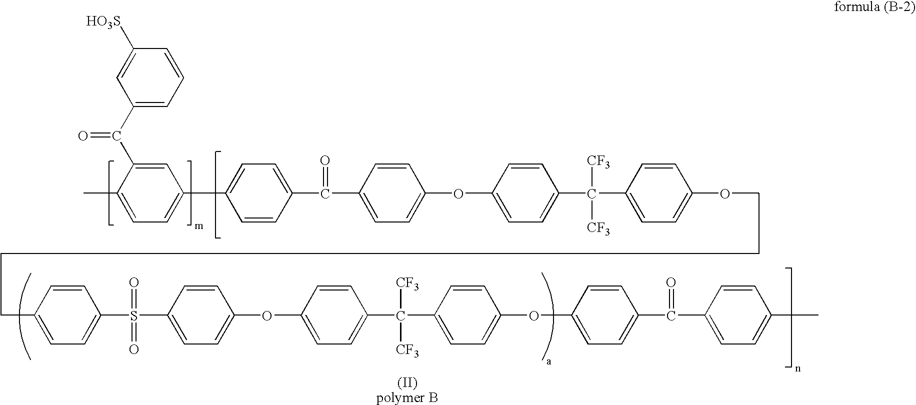

### Synthesis Example 3

(i) Synthesis of Hydrophobic Unit C

Into a 1 L three-necked flask equipped with a stirrer, a thermometer, a cooling pipe, a Dean-Stark apparatus, and a three-way stopcock for introducing nitrogen, were weighed 67.3 g (0.20 mol) of 2,2-bis(4-hyroxyphenyl)-1,1,1,3,3,3-hexafluoropropane, 60.3 g (0.24 mol) of 4,4′-dichlorobenzophenone (4,4′-DCBP), 71.9 g (0.52 mol) of potassium carbonate, 300 ml of N,N-dimethylacetamide (DMAc), and 150 ml of toluene. The mixture was heated by use of an oil bath and was allowed to react at 130 degrees C. under a nitrogen atmosphere while being stirred.

The reaction was carried out while the water generated through the reaction was co-disuntiled with toluene and removed through the Dean-Stark apparatus; after three hours, water generation fell to nearly zero. The temperature of the reaction mixture was then raised gradually from 130 degrees C. to 150 degrees C., and thus almost all of the toluene was removed. The mixture was allowed to further react at 150 degrees C. for 10 hours, and then 10.0 g (0.040 mole) of 4,4′-DCBP was added and was allowed to further react for 5 hours.

The resulting reaction liquid was allowed to cool, and then byproduct deposition of inorganic compounds was filtered out and the filtrate was poured into 4 L of methanol. The deposited product was filtered, collected, and dried, and then was dissolved into 300 ml of tetrahydrofuran, which was poured into 4 L of methanol to precipitate again, and thereby the intended product of 95 g was obtained in 85% yield.

The number average molecular weight of the resulting polymer was 11,200 based on a polystyrene standard by means of GPC using THF as the solvent. The resulting compound was the oligomer expressed by the formula (C-1) below. 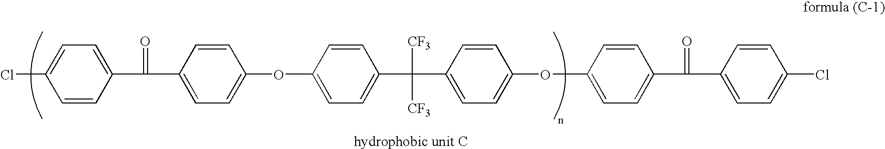
(ii) Synthesis of Sulfonated Polyarylene C

Into the mixture of 27.18 g (38.5 mmol) of the compound of monomer C expressed by the formula (C-2) below, 16.58 g (1.48 mmol) of the hydrophobic unit C synthesized in (i) described above, 0.79 g (1.2 mmol) of bis(triphenylphosphine)nickeldichloride, 4.20 g (16.0 mmol) of triphenylphosphine, 0.18 g (1.20 mmol) of sodium iodide and 6.28 g (96.1 mmol) of zinc was added to 100 ml of dried N,N-dimethylacetamide (DMAc) under a nitrogen atmosphere.

The reaction mixture was heated while stirring to 79 degrees C. for the last time and allowed to react for 3 hours. Viscosity increase of the reaction mixture was observed during the reaction period. The solution of polymerization reaction was diluted with 425 ml of DMAc, the mixture was stirred for 30 minutes, and then was filtered by use of celite as a filter aid.

A portion of the filtrate was poured into methanol and was thereby coagulated. The resulting copolymer, formed of a sulfonic acid derivative protected by a neopentyl group, had a molecular weight of Mn=59,400 and Mw=178,300.

The filtrate was concentrated into 344 g by use of an evaporator, to which was added 10.0 g (0.116 mole) of lithium bromide, and then the mixture was allowed to react at 110 degrees C. for 7 hours under a nitrogen atmosphere. After the reaction period, the reaction mixture was cooled to ambient temperature, and then was poured into 4 L of acetone to cause coagulation. The coagulated material was filtered, air-dried, and milled by a mixer, and then was washed with 1500 ml of 1N HCl while stirring. After filtration, the product was washed with deionized water until the pH of the washed water was no less than 5, dried at 80 degrees C. overnight, and thereby the intended sulfonated polymer of 23.0 g was obtained. The sulfonated polymer had a molecular weight of Mn=65,500 and Mw=197,000.

The ion-exchange capacity of the polymer was 2.0 meq/g. The resulting Polymer C having a sulfonic acid group was confirmed to be expressed by the formula (C-3) below.

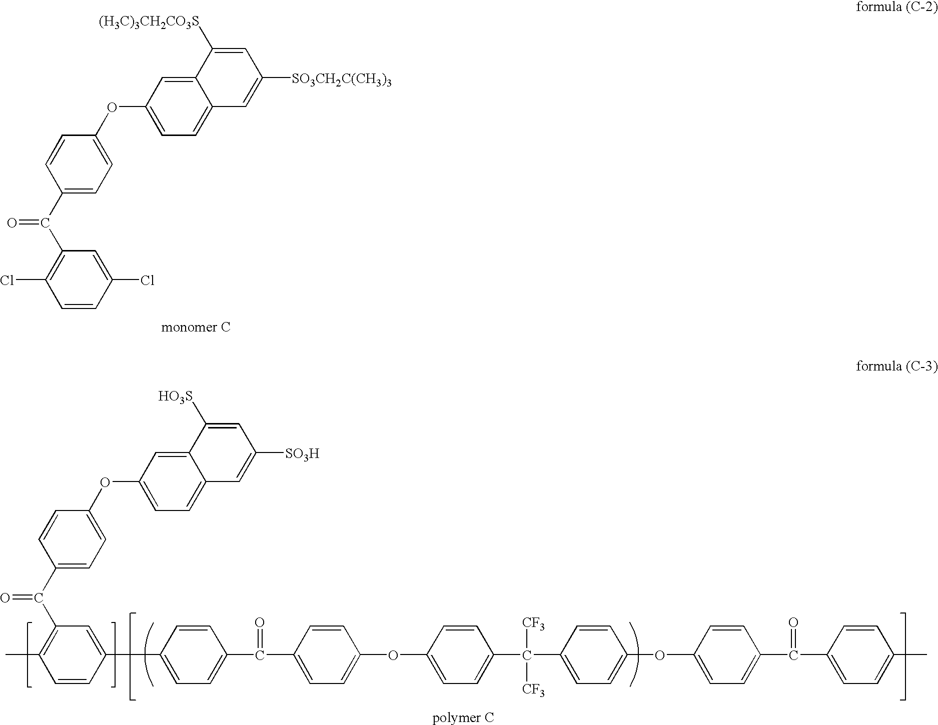

### EXAMPLES AND COMPARATIVE EXAMPLES

### Example 1

The sulfonated polyarylene A of Polymer A obtained in Synthesis Example 1 was dissolved into a mixture solvent of methanol/NMP=50/50 at a concentration of 15 mass %. To the solution, 3 mass parts of imidazole was added based on 100 mass parts of the sulfonated polyarylene A to prepare a varnish. A solid polymer electrolyte membrane 40 μm thick was produced from the varnish by means of a casting process, and then an assembly of solid polymer electrolyte membrane and electrode was prepared by use of the resulting membrane.

### Example 2

The sulfonated polyarylene B of Polymer B obtained in Synthesis Example 2 was dissolved into a mixture solvent of methanol/NMP=50/50 at a concentration of 15 mass %. To the solution, 3 mass parts of thiazole was added based on 100 mass parts of the sulfonated polyarylene B to prepare a varnish. A solid polymer electrolyte membrane 40 μm thick was produced from the varnish by means of a casting process, and then an assembly of a solid polymer electrolyte membrane and an electrode was prepared by use of the resulting membrane.

### Example 3

The sulfonated polyarylene C of Polymer C obtained in Synthesis Example 3 was dissolved into a mixture solvent of methanol/NMP=50/50 at a concentration of 15 mass %. To the solution, 2 mass parts of benzoxazole was added based on 100 mass parts of the sulfonated polyarylene C to prepare a varnish. A solid polymer electrolyte membrane 40 μm thick was produced from the varnish by means of a casting process, and then an assembly of solid polymer electrolyte membrane and electrode was prepared by use of the resulting membrane.

### Comparative Example 1

The sulfonated polyarylene A obtained in Synthesis Example 1 was dissolved into a mixture solvent of methanol/NMP=50/50 at a concentration of 15 mass % to prepare a varnish. A solid polymer electrolyte membrane 40 μm thick was produced from the varnish by means of a casting process, and then an assembly of a solid polymer electrolyte membrane and an electrode was prepared by use of the resulting membrane.

### Comparative Example 2

The sulfonated polyarylene B obtained in Synthesis Example 2 was dissolved into a mixture of solvents of methanol/NMP=50/50 at a concentration of 15 mass % to prepare a varnish. A solid polymer electrolyte membrane 40 μm thick was produced from the varnish by means of a casting process, and then an assembly of solid polymer electrolyte membrane and electrode was prepared by use of the resulting membrane.

### Comparative Example 3

The sulfonated polyarylene C obtained in Synthesis Example 3 was dissolved in a mixture of solvents methanol/NMP=50/50 at a concentration of 15 mass % to prepare a varnish. A solid polymer electrolyte membrane of 40 μm thick was produced from the varnish by means of a casting process, and then an assembly of solid polymer electrolyte membrane and electrode was prepared by use of the resulting membrane.

Evaluation

The assemblies of solid polymer electrolyte membrane and electrode obtained in the Examples and Comparative Examples were evaluated with respect to specific resistance, insoluble content, and power generating properties, in particular power generating performance and durability, in accordance with the procedures described below. The results are summarized in Table 1.

Measurement of Proton Conductivity

AC resistance was measured by pushing platinum wires of 0.5 mm diameter onto a surface of a test membrane, which was formed into a strip 5 mm in width, the test membrane was disposed in a controlled temperature/humidity chamber and then AC impedance was measured between the platinum wires. The impedance was measured for AC 10 kHz under conditions of 85 degrees C. and a relative humidity 90%. The measurements were performed by use of Chemical Impedance Measuring System (by NF Corporation), the controlled temperature/humidity chamber was Model JW241 (by Yamato Scientific Co., Ltd.). Five platinum wires were pushed onto the surface at an interval of 5 mm, the distance between the lines was varied within 5 to 20 mm, and AC resistance was measured. The specific resistance of membranes was then calculated from the slope of the relationship between line distances and resistances, and proton conductivity was determined as the inverse value of the specific resistance.
Specific Resistance R (ohm·cm)=0.5 (cm)×Membrane Thickness (cm)×Slope (ohm/cm)
Evaluation of Thermal Resistance

The respective films about 40 μm thick were held for 24 hours in an oven at 160 degrees C. The samples before and after the heating were immersed into the above-mentioned NMP-containing GPC eluting solvent at which each of the proton conductive membranes was 0.2 weight parts based on 99.8 weight parts of the GPC eluting solvent, and thereby the samples were exposed to a dissolving environment, and then insoluble matter was removed and GPC measurement was performed. The content of the insoluble matter was determined from the ratio of eluting areas before and after the heating.

Evaluation of Power Generating Property

Assemblies of solid polymer electrolyte membranes and electrodes were evaluated with respect to power generating properties under conditions in which the temperature was 70 degrees C., relative humidity was 60%/50% at both fuel electrode side/oxygen electrode sides, and the current density was 1 A/cm². Pure hydrogen was supplied to the fuel electrode side, and air was supplied to the oxygen electrode side. The durability was evaluated under the power generating conditions in which the cell temperature was 115 degrees C., the current density was 0.1 A/cm², and relative humidity was 40% at both fuel and oxygen electrode sides, and then the period up to cross-leak was reported. Durable generating periods of 300 hours or more were considered to be “satisfactory”, while periods of less than 300 hours was considered to be “unsatisfactory”.

TABLE 1

| | | | | | Thermal | | |
|---|---|---|---|---|---|---|---|
| | | | | | Resistance | Power | |
| | | Nitrogen- | Additive | Specific | Insoluble | Generating | Power |
| | Sulfonated | Containing | Amount | Resistance | Content | Property | Generating |
| | Polymer | Compound | (weight part) | (ohm-cm) | (wt %) | (V) | Durability |
| Ex. 1 | Polymer A | imidazole | 3 | 3.8 | 0 | 0.647 | satisfactory |
| Ex. 2 | Polymer B | thiazole | 3 | 3.2 | 0 | 0.635 | satisfactory |
| Ex. 3 | Polymer C | benzoxazole | 2 | 3.1 | 0 | 0.651 | satisfactory |
| Com. Ex. 1 | Polymer A | — | — | 3.6 | 80 | 0.651 | unsatisfactory |
| Com. Ex. 2 | Polymer B | — | — | 3.1 | 35 | 0.654 | unsatisfactory |
| Com. Ex. 3 | Polymer C | — | — | 3.0 | 15 | 0.659 | unsatisfactory |

Examples described above demonstrate that solid polymer electrolyte membranes may be provided with superior thermal resistance by virtue that nitrogen-containing aromatic compounds are incorporated in an amount of 0.01 to 20 mass parts, preferably 0.5 to 10 mass parts based on 100 mass parts of polyarylenes having a sulfonic acid group. Furthermore, the solid polymer electrolyte membranes according to the present invention may yield assemblies of solid polymer electrolyte membranes and electrodes that display excellent power generating properties and higher thermal resistance.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A membrane-electrode assembly for solid polymer electrolyte fuel cells, comprising: an anode electrode, a cathode electrode, and a solid polymer electrolyte membrane, the anode electrode and the cathode electrode disposed on opposite sides of the solid polymer electrolyte membrane,
wherein the solid polymer electrolyte membrane contains a polyarylene having sulfonic acid group and a nitrogen-containing heterocyclic aromatic compound.

2. The membrane-electrode assembly for solid polymer electrolyte fuel cells according to claim 1,
wherein the polyarylene having a sulfonic acid group further contains a repeating unit expressed by the general formula (A) shown below and a repeating unit expressed by the general formula (B) shown below: 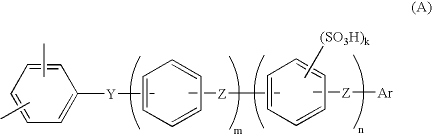
in the general formula (A), Y represents at least a structure selected from the group consisting of —CO—, —SO₂—, —SO—, —CONH—, —COO—, —(CF₂)₁— (1 is an integer of 1 to 10) and —C(CF₃)₂—;
Z represents a direct binding, or at least a structure selected from the group consisting of —(CH₂)₁— (1 is an integer of 1 to 10), —C(CH₃)₂—, —O— and —S—;
Ar represents an aromatic group having a substituent expressed by —SO₃H, —O(CH₂)ₚSO₃H or —O(CF₂)ₚSO₃H; in which p is an integer of 1 to 12; m is an integer of 0 to 10; n is an integer of 0 to 10; and k is an integer of 1 to 4; 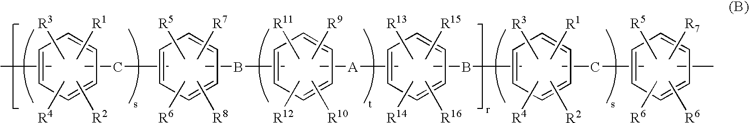
in the general formula (B), A and C represent independently a direct binding, or a structure selected from the group consisting of —CO—, SO₂—, —SO—, —CONH—, —COO—, —(CF₂)₁— (1 is an integer of 1 to 10), —C(CF₃)₂—, —(CH₂)₁— (1 is an integer of 1 to 10), —C(CR′₂)₂— (R′ is a hydrocarbon group or cyclic hydrocarbon group), —O— and —S—; B is independently an oxygen or sulfur atom; R¹ to R¹⁶, which may be identical or different from each other, represent at least an atom or a group selected from a hydrogen atom, fluorine atom, alkyl group, partly or fully halogenated alkyl group, allyl group, aryl group, nitro group and nitrile group; s and t are integers of 0 to 4; r is an integer of 0 or more than 1.

3. The membrane-electrode assembly for solid polymer electrolyte fuel cells according to claim 1, wherein the nitrogen-containing heterocyclic aromatic compound is included in an amount of 0.01 to 20 mass parts based on 100 mass parts of the polyarylene.

4. The membrane-electrode assembly for solid polymer electrolyte fuel cells according to claims 1, wherein the nitrogen-containing heterocyclic aromatic compound is at least one selected from the group consisting of pyrrole, thiazole, isothiazole, oxazole, isoxazole, pyridine, imidazole, pyrazole, 1,3,5-triazine, pyrimidine, pyridazine, pyrazine, indole, quinoline, isoquinoline, purine, benzimidazole, benzoxazole, benzthiazole, tetrazole, tetrazine, triazole, carbazole, acridine, quinoxaline, quinazoline, and derivatives thereof.
